(19) United States
(12) Patent Application Publication
(10) Pub. No.: US 2007/0178183 A1
(43) Pub. Date: Aug. 2, 2007

(54) Extrusion apparatus and adapters therefor

(75) Inventor: Keith Halliwell, Bolton (GB)

Correspondence Address: BLACKWELL SANDERS PEPER MARTIN LLP, 720 OLIVE STREET, SUITE 2400, ST. LOUIS, MO, 63101, US

(73) Assignee: BURNDEN HOLDINGS (UK) LIMITED, Bolton (GB)

(21) Appl. No.: 10/598,658

(22) PCT Filed: Mar. 1, 2005
(86) PCT No.: PCT/GB05/00753

§ 371 Date: Feb. 6, 2007

(30) Foreign Application Priority Data
Apr. 8, 2004 (GB) 0408017.2
Mar. 8, 2005 (GB) 0405124.9

(51) Int. Cl. B28B 21/52

(52) U.S. Cl. 425/464

(57) ABSTRACT

There is provided an adapter for an extrusion apparatus to split the flow of a molten material into a plurality of extrusion pathways (20), which adapter comprises an input channel (8), a first output channel (22), a second output channel (24) and means (26, 30) for adjusting the flow balance between the first output channel (22) and the second output channel (24).

### FIELD OF THE INVENTION

The present invention relates to adapters for extrusion apparatus, to extrusion apparatus incorporating such adapters and to methods of operating extrusion apparatus.

### BACKGROUND TO THE INVENTION

A typical plastics extrusion apparatus will operate at 400 Bar pressure and a typical temperature of 200° C. It is clearly desirable to maximise the efficient use of such extrusion apparatus bearing in mind its capital cost and ongoing running expenses. One known option for doing so is the provision of so-called Y-adapters which enable a single flow of molten material to be split into two equal flows to pass through substantially identical dies. The Y-adapter is fitted to the output of an extrusion apparatus.

This works satisfactorily for large scale production. However, if the maximum output of an extrusion apparatus exceeds the amount desired, maximum efficiency cannot be obtained. A dual-line extruder cannot be used for different dies because the flows have to be balanced. That is, an equal amount of molten material flows along each output channel of a known Y-adapter. If such an adapter is used with dies of different aggregate cross-sectional area, only the flow rate suitable for the lower flow rate die can be used. Accordingly, for reasons of efficiency, this is not done.

Another problem with known extrusion apparatus is the amount of space they take up, especially if a Y-adapter is used.

It is an aim of preferred embodiments of the present invention to provide an adapter for an extrusion apparatus and a corresponding extrusion apparatus and method of operation that addresses one or both sides of these problems.

### SUMMARY OF THE INVENTION

According to the present invention in a first aspect, there is provided an adapter for an extrusion apparatus to split the flow of a molten material into a plurality of extrusion pathways, which adapter comprises an input channel, a first output channel, a second output channel and means for adjusting the flow balance between the first output channel and the second output channel.

Suitably, the adapter comprises means for attachment to an extruder.

Suitably, the flow balance adjusting means is capable of controlling the flow balance to achieve at least a 60:40 split between the first channel and the second channel.

Suitably, at the output of the first channel there is provided a first die and the output of the second channel there is provided a second die, wherein the first and second dies differ substantially from one another.

Suitably, the flow balance adjusting means comprises a physical block restricting the flow of molten material into a channel.

Suitably, the flow balance adjusting means comprises a bellows.

Suitably, the flow balance adjusting means comprises a pivotable arm.

Suitably, the flow balance adjusting means comprises magnet means for biasing the flow of a polar molten material.

Suitably, the flow balance adjusting means comprises means for selectively adjusting the viscosity of molten fluid flow in a channel.

Suitably, the flow balance adjusting means comprises a temperature controlled body configured to adjust the temperature of the molten fluid flow in a channel.

Suitably, the temperature controlled body comprises a belt at least partly about a channel.

Suitably, the temperature controlled body comprises at least one fin projecting into a channel.

Suitably, a temperature controlled fluid is provided to control the temperature of the temperature controlled body.

Suitably, the first output channel is vertically spaced from the second output channel. Suitably, the first output channel lies above the second output channel.

According to the present invention in a second aspect there is provided an extrusion apparatus comprising an output to split the flow of a molten material into a plurality of extrusion pathways, which output comprises a first output channel, a second output channel and means for adjusting the flow balance between the first output channel and the second output channel.

Suitably, the first output channel is vertically spaced from the second output channel. Suitably, the first output channel lies above the second output channel.

Suitably, the output comprises an adapter according to the first aspect of the present invention.

According to the present invention in a third aspect, there is provided a method of operating an extrusion apparatus according to the second aspect of the present invention, which method comprises the steps of adjusting the flow balance adjusting means to balance the flow of molten material between a first dye of the first output channel and a second dye of the second output channel.

According to the present invention in a fourth aspect, there is provided an adapter for splitting the flow of a molten extrudate into a plurality of channels, the first channel having a first output channel and a second channel having a second output channel, wherein the first output channel is vertically spaced from the second output channel.

Suitably, the first output channel lies above the second output channel. Suitably the adapter is according to the first aspect of the present invention.

According to the present invention in a fifth aspect, there is provided an extrusion apparatus comprising an adapter according to the fourth aspect of the present invention.

Suitably, the first output channel is above the second output channel.

### BRIEF DESCRIPTION OF THE DRAWINGS

The present invention will now be described, by way of example only, with reference to the drawings that follow; in which:

FIG. 1 is a schematic perspective illustration of an adapter according to an embodiment of the present invention.

FIG. 2 is a cross-sectional elevation through the adapter of FIG. 1 on the line II-II.

FIG. 3 is a schematic side elevation of an extrusion apparatus incorporating an adapter according to the present invention.

FIG. 4 is a schematic illustration similar to FIG. 2 of a second embodiment of the present invention.

FIG. 5 is a schematic illustration similar to FIG. 2 of a third embodiment of the present invention.

FIG. 6 is a schematic illustration similar to FIG. 2 of a third embodiment of the present invention.

FIG. 7 is a view corresponding to FIG. 3 of a further embodiment of the present invention.

### DESCRIPTION OF THE PREFERRED EMBODIMENTS

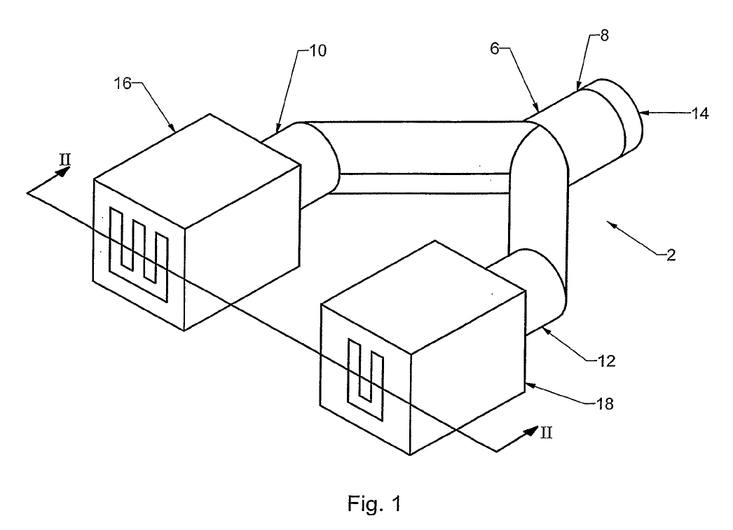

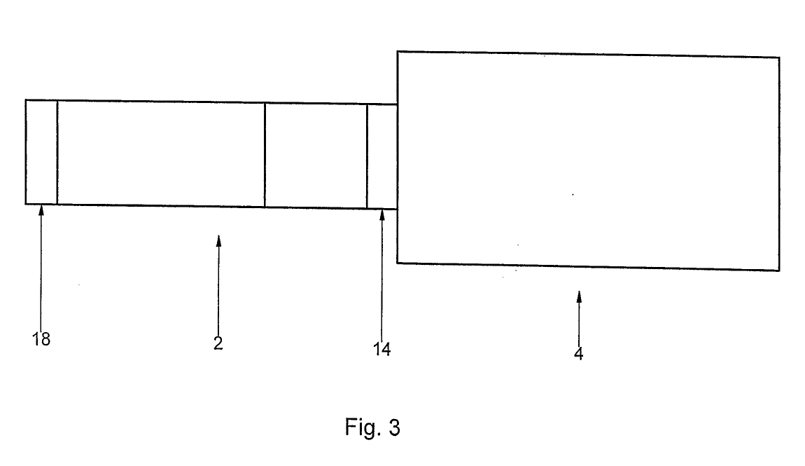

Referring to FIGS. 1-3 of the drawings that follow there is shown an adapter 2 according to an embodiment of the present invention. The adapter 2 is attached to the output of an extrusion apparatus 4 (see FIG. 3) of known configuration.

The adapter 2 comprises a generally Y-shaped main body 6 having an input 8 and two outputs 10, 12. About the input 8 is a fitting ring 14 for connecting the adapter 2 to the extrusion apparatus 4. At the output 10, 12 are located two different dies 16, 18 for shaping a molten material into an extrudate.

Within the main body 6 of adapter 2 there is an input channel 20 leading to a first output channel 22 and a second output channel 24, terminating in outputs 10, 12, respectively. In the input channel 20 is provided a flow balance adjusting means 26 controlled by controller 28.

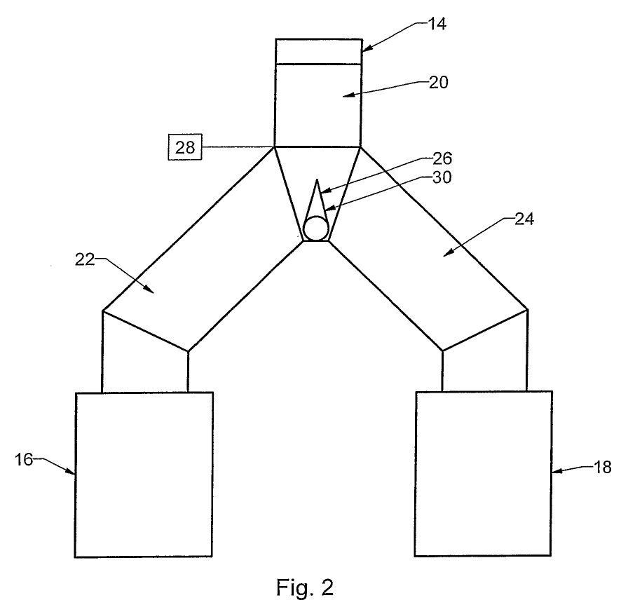

The flow balance adjusting means 26 can take many different forms. As shown in FIG. 2, there is provided a paddle arm 30 pivoting at the juncture of the first and second output channels 22, 24, respectively. Alternatively, a paddle arm could be provided pivoting at the other end thereof (i.e. upstream).

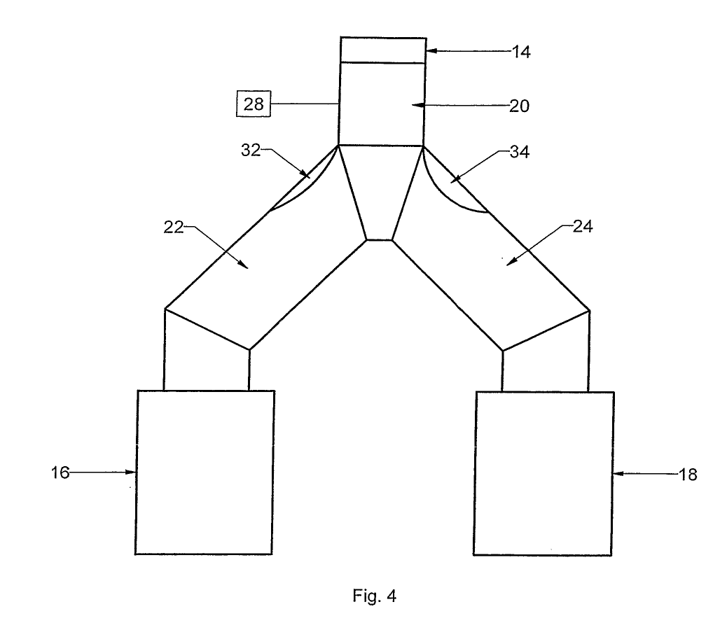

Referring to FIG. 4 of the drawings that follow, a similar construction is shown to that described in relation to FIGS. 1-3 with a different flow balance adjusting means 30. In this embodiment, the flow balance adjusting means comprises an inflatable bellows pair 32, 34 that can be independently inflated by a working fluid, typically a liquid to adjust the flow of molten material between the output channels 22, 24.

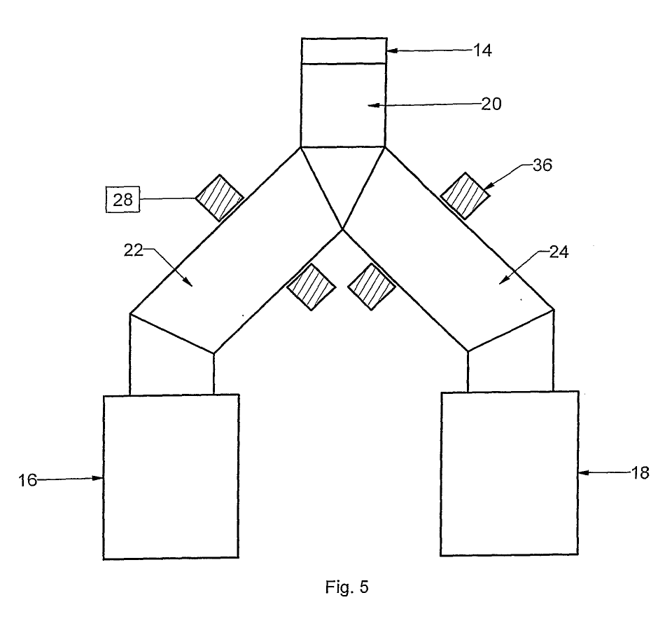

Referring to FIG. 5 of the drawings that follow, in a yet further embodiment of the present invention a flow balance adjusting means 36 comprises a high powered magnet which can be used for certain polar polymeric materials (such as poly vinyl chloride) to controllably adjust the flow between the two output channels 22, 24.

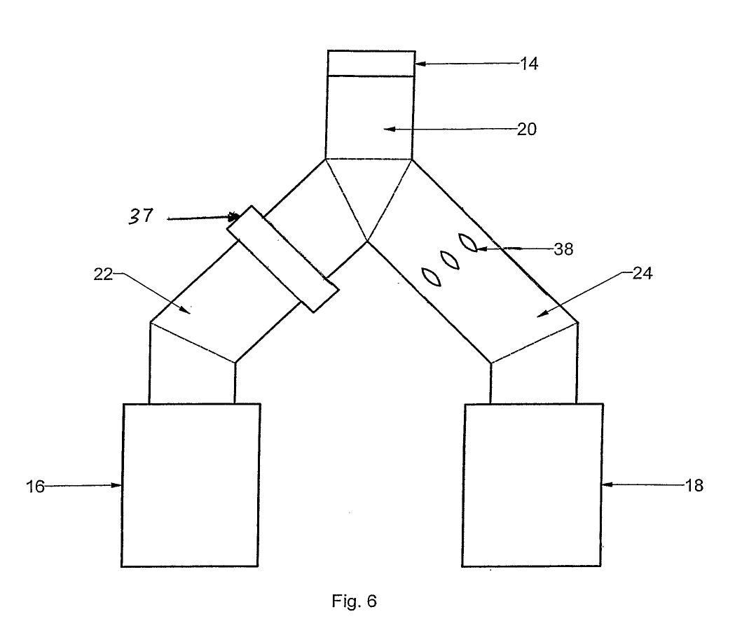

As a yet further option for a flow balance adjusting means, as shown in FIG. 6 of the drawings that follow, a belt 37 for a temperature controlled fluid flow, e.g. oil, or air can be provided about one or both channels 22, 24. The belt 37 can be partly or entirely around a channel 22, 24 Alternatively or in addition, coolant fluid can be provided to fins 38 projecting into the channels 22, 24. By independently controlling the liquid flow temperature in each belt, or fin the viscosity and hence flow rate in each channel can be controllably adjusted.

By adjusting the flow between the two output channels, the necessary balance between them can be maintained even though their outputs differ substantially. While it is desirable to be able to achieve a 0% to 100% alteration of the flow balance between the first and second outputs, achieving at least a 60:40 flow ratio between the two output channels can accommodate most requirements.

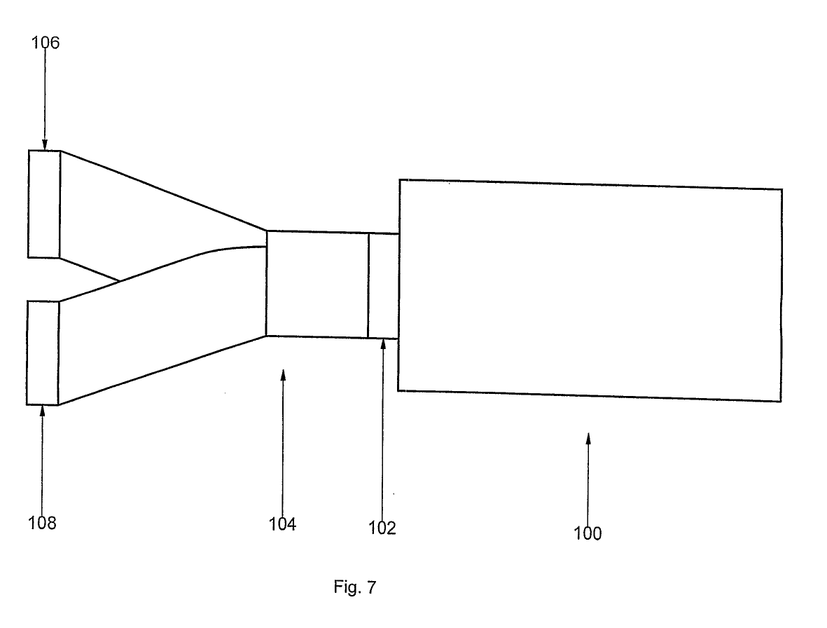

Referring to FIG. 7 of the drawings that follow, there is shown another embodiment of the present invention that can be used with or without the Y-adapter of the other embodiments. In this case there is provided an extrusion apparatus 100 comprising a fitting ring 102 and a Y-adapter 104 (as described above or otherwise), which Y-adapter is configured to be attachable and is attached to the fitting ring 102 whereby a first extrusion outlet 106 of the Y-adapter 104 is vertically spaced from a second extrusion outlet 108 of the Y-adapter 104. Preferably the first extrusion outlet 106 is above (i.e. at least partly vertically in line with) the second extrusion outlet 168. According to such an embodiment, there is a reduced footprint for the extrusion apparatus.

In use, the flow balance adjustment means is used to adjust the ratio of flow of molten material between the two output channels so that the maximum throughput can be achieved through substantially different dies. The amount of bias between the two channels is determined by iteratively adjusting the flow balance until a suitable flow rate differential is achieved.

A flow rate need only be changed in one output channel to provide the desired flow rate differential.

Although described in relation to a two channel adapter, it will be appreciated that the present invention is applicable in multi-channel adapter applications also.

Accordingly, two different existing dies can be used on an adapter providing two or more outputs from an extrusion apparatus. The invention can be embodied in an extrusion apparatus comprising an extruder output with two or more channels that is not an adapter.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An adapter for an extrusion apparatus to split the flow of a molten material into a plurality of extrusion pathways, which adapter comprises an input channel, a first output channel, a second output channel and means for adjusting the flow balance between the first output channel and the second output channel.

2. An adapter according to claim 1, in which the adapter comprises means for attachment to an extruder.

3. An adapter according to claim 1, in which the flow balance adjusting means is capable of controlling the flow balance to achieve at least a 60:40 split between the first channel and the second channel.

4. An adapter according to claim 1, in which at the output of the first channel there is provided a first die and the output of the second channel there is provided a second die, wherein the first and second dies differ substantially from one another.

5. An adapter according to claim 1, in which the flow balance adjusting means comprises a physical block restricting the flow of molten material into a channel.

6. An adapter according to claim 1, in which the flow balance adjusting means comprises a bellows.

7. An adapter according to claim 1, in which the flow balance adjusting means comprises a pivotable arm.

8. An adapter according to claim 1, in which the flow balance adjusting means comprises magnet means for biasing the flow of a polar molten material.

9. An adapter according to claim 1, in which the flow balance adjusting means comprises means for selectively adjusting the viscosity of molten fluid flow in a channel.

10. An adapter according to claim 9, which the flow balance adjusting means comprises a temperature controlled body configured to adjust the temperature of the molten fluid flow in a channel.

11. An adapter according to claim 10 in which the temperature controlled body comprises a belt at least partly about a channel.

12. An adapter according to claim 10, in which the temperature controlled body comprises at least one fin projecting into a channel.

13. An adapter according to claim 10, in which a temperature controlled fluid is provided to control the temperature of the temperature controlled body.

14. An adapter according to claim 1, in which the first output channel is vertically spaced from the second output channel.

15. An adapter according to claim 14, in which the first output channel lies above the second output channel.

16. An extrusion apparatus comprising an output to split the flow of a molten material into a plurality of extrusion pathways, which output comprises a first output channel, a second output channel and means for adjusting the flow balance between the first output channel and the second output channel.

17. An adapter according to claim 16 in which the first output channel is vertically spaced from the second output channel.

18. An adapter according to claim 16, in which the first output channel lies above the second output channel.

19. An adapter according to claim 16, in which the output comprises an adapter according to claim 1.

20. A method of operating an extrusion apparatus according to claim 16, which method comprises the steps of adjusting the flow balance adjusting means to balance the flow of molten material between a first dye of the first output channel and a second dye of the second output channel.

21. An adapter for splitting the flow of a molten extrudate into a plurality of channels, the first channel having a first output channel and a second channel having a second output channel, wherein the first output channel is vertically spaced from the second output channel.

22. An adapter according to claim 21, in which the first output channel lies above the second output channel.

23. An adapter according to claim 22, in which the adapter is according to claim 1.

24. An extrusion apparatus comprising an adapter according to claim 21.

25. An extrusion apparatus according to claim 24, in which the first output channel is above the second output channel.
